(19) United States
(12) Patent Application Publication
(10) Pub. No.: US 2026/0280832 A1
(43) Pub. Date: Sep. 17, 2026

(54) METHOD AND APPARATUS FOR DEVICE COLLABORATION IN UNLICENSED BAND IN MOBILE COMMUNICATIONS

(71) Applicant: MEDIATEK INC., Hsinchu City (TW)

(72) Inventors: Lung-Sheng TSAI, Hsinchu City (TW); Kuan-Yuan CHEN, Hsinchu City (TW)

(73) Assignee: MEDIATEK INC., Hsinchu City (TW)

(21) Appl. No.: 19/472,802

(22) PCT Filed: Aug. 27, 2024
(86) PCT No.: PCT/CN2024/114760

§ 371 Date: Oct. 6, 2025

Related U.S. Application Data
(60) Provisional application No. 63/579,049, filed on Aug. 28, 2023.
(60) Provisional application No. 63/556,435, filed on Feb. 22, 2024.

(51) Int. Cl. H04L 5/00; H04L 1/00

(52) U.S. Cl. CPC H04L 5/0098; H04L 1/0003; H04L 5/0044

(57) ABSTRACT

Examples pertaining to device collaboration in an unlicensed band in mobile communications are described. A first communication apparatus may receive a configuration message including a first uplink transmission configuration and a second uplink transmission configuration for signal transmission at least in a first frequency band. The first uplink trans-MESSAGE mission configuration and the second uplink transmission configuration indicate transmission parameter. The first communication apparatus may transmit a first set of encoded bits to the network node through the first frequency band and a second set of encoded bits to a second communication apparatus through an unlicensed band for the second communication apparatus to transmit the second set of encoded bits to the network node through the first frequency band based on the first uplink transmission configuration when determining that the transmission in the unlicensed band between the first communication apparatus and the second communication apparatus proximal thereto is available.

### CROSS REFERENCE TO RELATED PATENT APPLICATION(S)

The present disclosure is part of a non-provisional application claiming the priority benefits of U.S. Patent Application No. 63/579,049, filed on 28 Aug. 2023 and U.S. Patent Application No. 63/556,435, filed on 22 Feb. 2024, the contents of which herein being incorporated by reference in their entireties.

### TECHNICAL FIELD

The present disclosure is generally related to mobile communications and, more particularly, to device collaboration in an unlicensed band with respect to user equipment and network apparatus in mobile communications.

### BACKGROUND

Unless otherwise indicated herein, approaches described in this section are not prior art to the claims listed below and are not admitted as prior art by inclusion in this section.

As 5G technology continues to evolve and expand, the New Radio (NR) network can support a wider range of applications for mobile communication devices, such as mobile phones and associated peripheral smart devices. In daily life, users might simultaneously carry a mobile phone and a smartwatch (and/or other peripheral smart devices). Each of these mobile communication devices may have an independent communication function for connecting to the NR network and may camp on the same base station, which is usually called a gNB (or gNodeB).

However, due to the demands for compactness and portability and to meet safety regulations, such as the Specific Absorption Rate (SAR), each mobile communication device is limited in the number of antennas (e.g., two antennas) for mobile communication. Therefore, the MIMO (Multiple Input Multiple Output) transmission between the gNB and the mobile communication device is constrained, especially in the uplink transmission.

Although some operators have suggested using unlicensed bands with the assistance of a nearby mobile communication device for uplink signal transmission to the gNB to achieve more layers of spatial multiplexing, the use of the unlicensed band is uncertain because it is not a dedicated resource and must be contested for access. Furthermore, the only way the gNB can know whether the unlicensed band is available is through the report from the mobile communication device. In this scenario, if the gNB has configured the uplink signal transmission parameters based on the condition that the unlicensed band is available as reported by the mobile communication device, by the time the mobile communication device is ready to perform the uplink signal transmission through its antennas and the nearby mobile communication device's antennas, it may encounter the situation where the unlicensed band temporarily becomes unavailable, resulting in that the uplink signal, which requires transmission to the gNB through the nearby mobile communication device's antennas, cannot first be transmitted to the nearby mobile communication device via the unlicensed band. Consequently, the communication device will not be able to transmit the uplink signal through both its antennas and the nearby mobile communication device's antennas according to the uplink signal transmission parameters previously configured by the gNB and will need to request the gNB to configure new uplink signal transmission parameters for the mobile communication device to perform the uplink signal transmission only by itself, which not only causes waste of uplink resources but also consumes the mobile communication device's power and greatly reduces the uplink transmission efficiency.

Accordingly, the industry is striving to provide a communication mechanism for effectively using unlicensed bands for uplink signal transmission to the gNB, aiming to achieve more layers of spatial multiplexing and solve some or all of the above problems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that provide a communication mechanism for effectively using unlicensed bands for uplink signal transmission to the gNB, aiming to achieve more layers of spatial multiplexing and prevent unnecessary uplink resource waste, unnecessary power consumption of the mobile communication device and uplink transmission efficiency reduction.

In one aspect, a method may involve an apparatus receiving a configuration message from a network node. The configuration message includes a first uplink transmission configuration and a second uplink transmission configuration for signal transmission at least in a first frequency band. The first uplink transmission configuration and the second uplink transmission configuration indicate transmission parameters. The method may also involve the apparatus determining whether a transmission in a second frequency band between the apparatus and a device is available. The second frequency band includes an unlicensed band. The method may further involve the apparatus transmitting a first set of encoded bits to the network node through the first frequency band and a second set of encoded bits through the second frequency band based on the first uplink transmission configuration in an event that the transmission in the second frequency band is available.

In one aspect, a method may involve an apparatus transmitting a configuration message to a UE. The configuration message includes a first uplink transmission configuration and a second uplink transmission configuration for signal transmission at least in a first frequency band. The first uplink transmission configuration and the second uplink transmission configuration indicate transmission parameters. The first uplink transmission configuration and the second uplink transmission configuration are associated with two different sets of uplink transmissions for the UE in a time unit. The method may also involve the apparatus receiving, in the time unit, either a first set of encoded bits and a second set of encoded bits through the first frequency band based on the first uplink transmission configuration or a third set of encoded bits through the first frequency band based on the second uplink transmission configuration.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, a configuration message from a network node. The configuration message includes a first uplink transmission configuration and a second uplink transmission configuration for signal transmission at least in a first frequency band. The first uplink transmission configuration and the second uplink transmission configuration indicate transmission parameters. The processor, during operation, may also perform operations comprising determining whether a transmission in a second frequency band between the apparatus and a device is available. The second frequency band includes an unlicensed band. The processor, during operation, may further perform operations comprising transmitting, via the transceiver, a first set of encoded bits to the network node through the first frequency band and a second set of encoded bits through the second frequency band based on the first uplink transmission configuration in an event that the transmission in the second frequency band is available.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIGS. 1A-1C are diagrams depicting example scenarios under schemes in accordance with implementations of the present disclosure.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to device collaboration in an unlicensed band in mobile communications. According to the present disclosure, a number of possible solutions may be implemented separately or jointly. That is, although these possible solutions may be described below separately, two or more of these possible solutions may be implemented in one combination or another.

The communication mechanism of the present disclosure is applicable to a mobile communication network (e.g., an LTE network, a 5G/NR network, an IoT network or a 6G network). In this mobile communication network, a first UE and a second UE may camp on the same network node which provides a wide area coverage for long-range communication. In addition, the first UE and the second UE may be located in close proximity to each other and may establish a short-range wireless connection with each other to perform a short-range communication over an unlicensed band.

The network node provides two different uplink transmission configurations for the first UE to transmit the uplink data through a licensed band. One of the uplink transmission configurations further involves using the unlicensed band with the assistance of the second UE for uplink transmission. The first UE may perform a sensing procedure (e.g., the Listen Before Talk (LBT) procedure) to determine whether the transmission in the unlicensed band between the first UE and the second UE is available. The first UE may select one of the uplink transmission configurations to perform the uplink transmission, depending on whether the transmission in the unlicensed band is available.

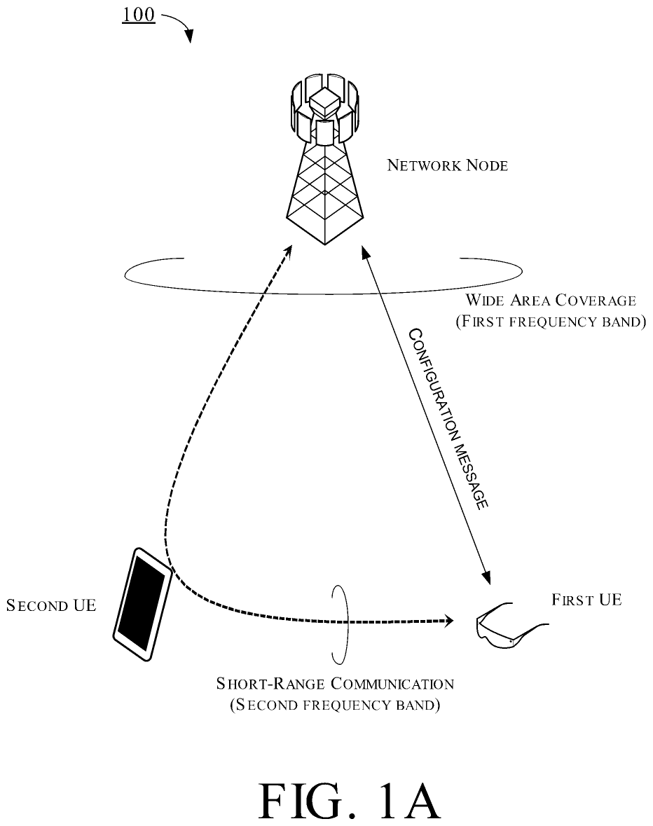

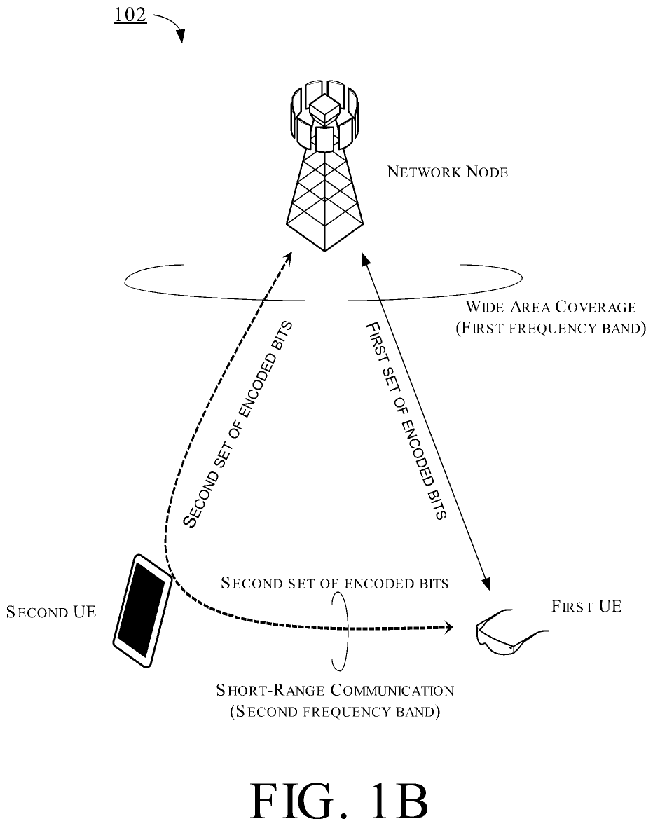

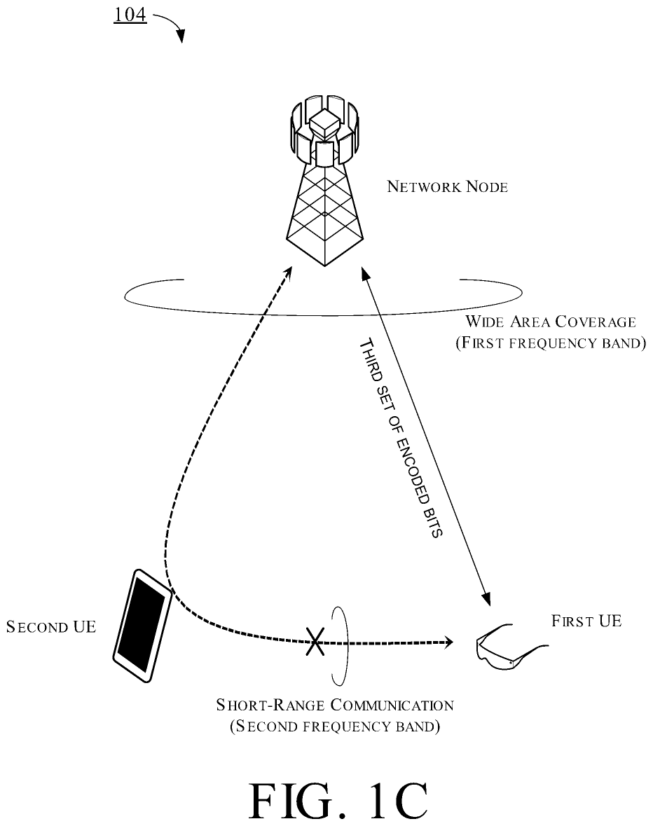

FIGS. 1A to 1C illustrate example scenarios 100, 102 and 104 under schemes in accordance with implementations of the present disclosure. Scenarios 100, 102 and 104 involve a mobile communication network (e.g., an NR network) including a network node (e.g., a gNB of the NR network), a first UE (e.g., a smart glass), and a second UE (e.g., a mobile phone) proximal to the first UE. In the network framework of Scenarios 100, 102 and 104, the first UE may camp on the network node for long-range communication. The first UE transmits signals to the network node in a first frequency band. At the same time, the first UE also transmits signals to the second UE in a second frequency band. In some implementations, the second UE acts as a frequency translating repeater to forward signals transmitted by the first UE to the network node: it receives RF signals on the second frequency band, shifts/translates the RF carrier of the RF signals to the first frequency band, and then transmits the shifted/translated RF signals on the first frequency band. Each frequency band is an interval in frequency domain. The second frequency band is in an unlicensed band. The first UE and the second UE may connect to each other to perform a short-range communication or signal-forwarding through the unlicensed band. For example, when the second frequency band is an unlicensed band, the first UE may perform signal transmission therebetween by contesting the resources in the unlicensed band with other devices first. The network node receives signals from both the first UE and the second UE in the first frequency as the connection between the first UE and the second UE is transparent.

Since the first UE and the second UE may be located in close proximity to each other, the first UE may utilize the second UE to forward RF signals carrying uplink data to the network node to achieve more layers of spatial multiplexing, and vice versa. In scenarios 100, 102 and 104, the first UE may act as a primary UE and the second UE may act as a collaborative UE to assist the first UE in uplink transmission. Comparing to a direct transmission from the first UE to the network node, a collaborative transmission from both the first UE and the second UE provides additional power gain and antenna gain.

The network node may generate a configuration message, and the first UE may receive a configuration message from the network node, as shown in FIG. 1A. The configuration message may be signaled to the first UE dynamically via a physical downlink control channel. The configuration message may include a first uplink transmission configuration and a second uplink transmission configuration for signal transmission at least in a first frequency band. The first uplink transmission configuration and the second uplink transmission configuration may indicate transmission parameters. The first uplink transmission configuration may be associated with an uplink transmission through a first frequency band using a first uplink resource (i.e., a time-frequency resource associated with a set of resource blocks in a time unit) and an uplink transmission through a second frequency band. The first uplink resource includes resource blocks allocated to the first UE for its uplink transmission in the first band. The first uplink resource may also imply resource blocks allocated to the first UE for its uplink transmission in the second band, because a constant frequency offset between resource in the first frequency band and resource in the second frequency band is expected. The second uplink transmission configuration may be associated with an uplink transmission through the first frequency band using a second uplink resource (which may be identical to the first uplink resource or at least include the first uplink resource, but not limited thereto). The first frequency band is a licensed band used for mobile communication in the mobile communication network. The first uplink transmission configuration may be generated by the network node based on the measurement of uplink reference signals. For example, the network node may measure a set of sounding reference signals (SRSs) transmitted by the first UE through the first frequency band and measure another set of SRSs first transmitted by the first UE to the second UE through a second frequency band, then amplified and forwarded by the second UE to the network node through the first frequency band. In some implementations, the two sets of SRSs are two separately configured SRS resources. In some implementations, the two sets of SRSs are corresponding to two groups of ports within a configured SRS resource in the first frequency band. The second frequency band may be an unlicensed band in which the resource for signal transmission is to be contested. The forwarded SRSs may be not available if the first UE fails in contesting the resource in the unlicensed band so the first UE does not transmit any signal in the second band. In an event that the forwarded SRSs are measurable, the network node can determine transmission parameters for data transmission of the first UE in both the first frequency band and the second frequency band, based on the measurement results on the forwarded SRSs and the SRSs directly transmitted from the first UE in the first frequency band.

Similarly, the second uplink transmission configuration may also be generated by the network node based on the measurement result of uplink reference signals, e.g., the sounding reference signals (SRSs) transmitted by the first UE through the first frequency band. Therefore, the first uplink transmission configuration and the second uplink transmission configuration are associated with two different sets of uplink transmissions (i.e., different channel responses) for the first UE in a time unit.

Upon receiving the configuration message from the network node, the first UE may determine whether a transmission in the second frequency band between the first UE and the second UE is available. For example, the first UE may perform a sensing procedure (e.g., the Listen Before Talk (LBT) procedure) to determine whether the second frequency band is available for data transmission. It shall be appreciated that the time at which the first UE performs the sensing procedure is not limited, i.e., any time prior to the transmission of the uplink data using the uplink resource indicated in the configuration message is feasible.

FIG. 1B illustrates scenario 102, in which the first UE determines that transmission in the second frequency band is available. In this case, the first UE may transmit a first set of encoded bits to the network node through the first frequency band using the first uplink resource (i.e., along a first transmission path from the first UE to the network node) and may transmit a second set of encoded bits to the second UE through the second frequency band so that the second UE may forward the second set of encoded bits to the network node through the first frequency band using the first uplink resource as well (i.e., along a second transmission path from the first UE, through the second UE, and to the network node) based on the first uplink transmission configuration. The second UE is capable of forwarding the second set of encoded bits by transforming the second frequency band to the first frequency band without decoding the second set of encoded bits.

The network node may receive a first set of encoded bits and a second set of encoded bits through the first frequency band. It may receive the two sets of encoded bits on the same set of resource blocks in the first frequency band based on the first uplink transmission configuration. Therefore, the first UE may simultaneously transmit a part of the uplink data (i.e., the first set of encoded bits) using its antennas and utilize the antennas of the second UE to transmit another part of the uplink data (i.e., the second set of encoded bits) to the network node through the same uplink source (i.e., the first uplink resource) in the first frequency band to achieve more layers of spatial multiplexing. In some implementations, the second UE may directly amplify and forward (i.e., transfer the carrier frequencies to the first frequency band) the signal carrying the second set of encoded bits to the network node through the first uplink resource.

In some implementations, the first uplink transmission configuration may indicate a first set of transmission parameters for transmitting the first set of encoded bits through the first frequency band and a second set of transmission parameters for transmitting the second set of encoded bits through the second frequency band and the first frequency band via the second UE. For example, the first set of transmission parameters may include at least one of a first rank indication (RI), a first modulation and coding scheme (MCS), a first transmission precoding matrix indicator (TPMI) and a first demodulation reference signal (DMRS) configuration, and the second set of transmission parameters may include at least one of a second RI, a second MCS, a second TPMI and a second DMRS configuration. In some cases, the channel quality between the second UE and the network node is better than that between the first UE and the network node, and therefore, the second MCS is higher than the first MCS. In some cases, the values of the first and second RIs may be two if the first and second UEs both have two antennas for mobile communication. However, these transmission parameters will vary depending on the real-time channel quality and the number of antennas on the UEs.

In some implementations, the first set of encoded bits corresponds to a first codeword (CW) or a first transport block (TB), and the second set of encoded bits corresponds to a second CW or a second TB. In the present disclosure, the uplink data is split into two units carried by the first set of encoded bits and the second set of encoded bits separately, each of which is capable of being independently encoded and decoded. Therefore, in some cases, the retransmission of data carried by either the first set of encoded bits or the second set of encoded bits may be performed individually without retransmission of the entire uplink data (i.e., data carried by both the first set of encoded bits and the second set of encoded bits).

In some embodiments, the first UE may receive a control message from the network node for retransmission of data carried by at least one of the first set of encoded bits and the second set of encoded bits. Then, the first UE may retransmit the data to the network node through the first frequency band according to the control message. For example, if one of the first set of encoded bits and the second set of encoded bits cannot pass a cyclic redundancy check (CRC), the network node may transmit downlink control information (DCI) carrying the control message to instruct the first UE to retransmit the data carried by the first set of encoded bits and/or the second set of encoded bits, depending on which one did not pass the CRC. The control message may indicate at least one uplink resource in the first frequency band for retransmission. As a result, the first UE may retransmit the data using its antennas (i.e., using the first transmission path) and/or using the antennas of the second UE (i.e., using the second transmission path). The network node may receive the data through at least one uplink retransmission resource in the first frequency band according to the control message.

In some embodiments, the first UE may transmit a third set of encoded bits to the network node through the first frequency band using the second uplink resource based on the second uplink transmission configuration when the transmission in the second frequency band is not available, as shown in FIG. 1C. In consideration of effective resource utilization, the second uplink resource may be identical to the first uplink resource (i.e., the same set of resource blocks in the time unit) or at least include the first uplink resource, but not limited thereto. The second frequency band (i.e., the unlicensed band) may not be available due to interference from other devices. However, benefiting from the advantage that the network node provides two optional uplink transmission configurations, the first UE may still be able to transmit the uplink signal based on the other uplink transmission configuration (i.e., the second uplink transmission configuration). Therefore, the network node may receive the third set of encoded bits through the second uplink resource in the first frequency band according to the second uplink transmission configuration.

The second uplink transmission configuration may indicate a third set of transmission parameters for transmitting the third set of encoded bits. The third set of transmission parameters indicated in the second uplink transmission configuration may be different from the first set of transmission parameters and/or the second set of transmission parameters indicated in the first uplink transmission configuration.

In some implementations, the second uplink resource in the first frequency band may be identical to the first uplink resource in the first frequency band. Compared with the MCSs indicated in the first uplink transmission configuration, the second uplink transmission configuration may indicate higher RI or MCS for the first UE to transmit the third set of encoded bits including more information bits than the first set of encoded bits through the second uplink resource (i.e., the same set of resource blocks in the time unit as the first uplink resource). The third set of transmission parameters may include at least one of a third RI, a third MCS, a third TPMI and a third DMRS configuration. The third set of encoded bits may correspond to a third CW or a third TB.

In some implementations, the third set of encoded bits may be identical to the first set of encoded bits. Thus, the second uplink transmission configuration may indicate the third set of transmission parameters, which is identical to the first set of transmission parameters as indicated in the first uplink transmission configuration, for the first UE to transmit the third set of encoded bits through the first frequency band using the first uplink resource. However, in other implementations, the second uplink transmission configuration may indicate that the third set of transmission parameters refers to or defaults to the first set of transmission parameters indicated in the first uplink transmission configuration. In other words, the network node may only provide the first uplink transmission configuration, and the first UE by default treats the first set of transmission parameters as the second uplink transmission configuration to be followed when the transmission in the second frequency band is not available.

In some implementations, the second uplink resource in the first frequency band may include the first uplink resource and an additional uplink resource in the first frequency band. The second uplink transmission configuration may indicate the third set of transmission parameters different from the first and second sets of transmission parameters (e.g., different MCSs) for the first UE to transmit the third set of encoded bits and a fourth set of encoded bits through the first uplink resource and the additional uplink resource in the first frequency band, respectively. The third set of encoded bits may correspond to a third CW or a third TB, and the fourth set of encoded bits may correspond to a fourth CW or a fourth TB.

In some implementations, the second uplink transmission configuration may indicate the third set of transmission parameters, which includes the first set of transmission parameters as indicated in the first uplink transmission configuration, for the first UE to transmit the third set of encoded bits through the first uplink resource in the first frequency band. In addition, the third set of transmission parameters may include another set of transmission parameters for the first UE to transmit the fourth set of encoded bits through the additional uplink resource in the first frequency band. In some cases, the third set of encoded bits may be identical to the first set of encoded bits, and the fourth set of encoded bits may be different from the second set of encoded bits, but they are not limited thereto.

In some implementations, the second uplink transmission configuration may only indicate another set of transmission parameters for the first UE to transmit the fourth set of encoded bits through the additional uplink resource in the first frequency band. With respect to the third set of transmission parameters for the transmission of the third set of encoded bits, it may refer or default to the first set of transmission parameters indicated in the first uplink transmission configuration.

In some embodiments, the first UE may transmit an uplink report message to the network node. The uplink report message may indicate which one of the first uplink transmission configuration and the second uplink transmission configuration is used for uplink transmission in the first frequency band or whether the transmission in the second frequency band is available. In some implementations, the first UE may transmit the uplink report message along with the first set of encoded bits through the first uplink resource. For example, the uplink report message may be included in the first set of encoded bits.

In some embodiments, the first UE may transmit a first set of reference signals (e.g., DMRSs) associated with the first set of encoded bits in the first frequency band to the network node and a second set of reference signals (e.g., DMRSs) associated with the second set of encoded bits in the second frequency band to the network node via the second UE when the transmission in the second frequency band is available. The network node may determine to use the first uplink transmission configuration for uplink transmission in the first frequency band when the second set of reference signals is received. Instead, the network node may determine to use the second uplink transmission configuration for uplink transmission in the first frequency band when the second set of reference signals is not received. In other words, the network node may perform blind detection by detecting the presence of the second set of reference signals without the need for the uplink report message, as mentioned above.

In some embodiments, the network node may directly attempt to receive the first set of encoded bits and the second set of encoded bits based on the first uplink transmission configuration while simultaneously receiving the third set of encoded bits based on the second uplink transmission configuration. The network node may then attempt to decode the received data corresponding to the first uplink transmission configuration and decode the received data corresponding to the second uplink transmission configuration to determine which can be correctly decoded.

### Illustrative Implementations

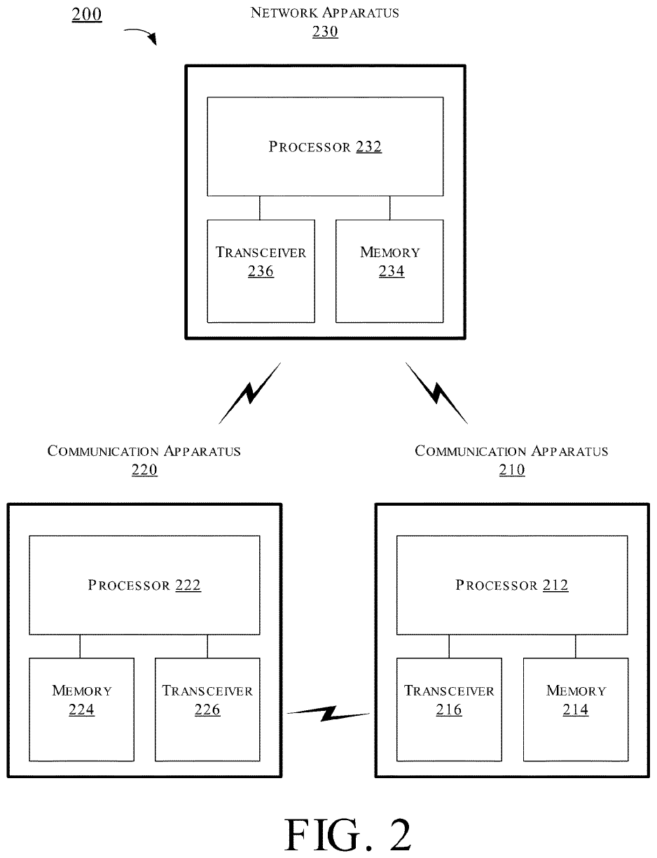

FIG. 2 illustrates an example communication system 200 having an example communication apparatus 210, an example communication apparatus 220, and an example network apparatus 230 in accordance with an implementation of the present disclosure. Each of communication apparatus 210, communication apparatus 220 and network apparatus 230 may perform various functions to implement schemes, techniques, processes and methods described herein pertaining to device collaboration in an unlicensed band in mobile communications, including scenarios/schemes described above as well as process 300, process 400 and process 500 described below.

Communication apparatus 210/220 may be a part of an electronic apparatus, which may be a UE such as a portable or mobile apparatus, a wearable apparatus, a mobile communication apparatus or a computing apparatus. For instance, communication apparatus 210/220 may be implemented in a smartphone, a smartwatch, a personal digital assistant, a digital camera, or a computing equipment such as a tablet computer, a laptop computer or a notebook computer. Communication apparatus 210/220 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 210/220 may be implemented in a smart thermostat, a smart fridge, a smart door lock, a wireless speaker or a home control center. Alternatively, communication apparatus 210/220 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210/220 may include at least some of those components shown in FIG. 2 such as a processor 212/222, for example. Communication apparatus 210/220 may further include one or more other components not pertinent to the proposed scheme of the present disclosure (e.g., internal power supply, display device and/or user interface device), and, thus, such component(s) of communication apparatus 210/220 are neither shown in FIG. 2 nor described below in the interest of simplicity and brevity.

Network apparatus 230 may be a part of a network device, which may be a network node such as a satellite, a base station, a small cell, a router or a gateway. For instance, network apparatus 230 may be implemented in an eNodeB in an LTE network, in a gNB in a 5G/NR, IoT, NB-IoT or IIoT network or in a satellite or base station in a 6G network. Alternatively, network apparatus 230 may be implemented in the form of one or more IC chips such as, for example and without limitation, one or more single-core processors, one or more multi-core processors, or one or more RISC or CISC processors. Network apparatus 230 may include at least some of those components shown in FIG. 2 such as a processor 232, for example. Network apparatus 230 may further include one or more other components not pertinent to the proposed scheme of the present disclosure (e.g., internal power supply, display device and/or user interface device), and, thus, such component(s) of network apparatus 230 are neither shown in FIG. 2 nor described below in the interest of simplicity and brevity.

In one aspect, each of processor 212, processor 222 and processor 232 may be implemented in the form of one or more single-core processors, one or more multi-core processors, or one or more CISC processors. That is, even though a singular term “a processor” is used herein to refer to processor 212, processor 222 and processor 232, each of processor 212, processor 222 and processor 232 may include multiple processors in some implementations and a single processor in other implementations in accordance with the present disclosure. In another aspect, each of processor 212, processor 222 and processor 232 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212, processor 222 and processor 232 is a special-purpose machine specifically designed, arranged and configured to perform specific tasks including device collaboration in an unlicensed band in a device (e.g., as represented by communication apparatus 210 and communication apparatus 220) and a network (e.g., as represented by network apparatus 230) in accordance with various implementations of the present disclosure.

In some implementations, communication apparatus 210 may also include a transceiver 216 coupled to processor 212 and capable of wirelessly transmitting and receiving data. In other words, processor 212 may transceive the data such as configuration, message, signal, information, indicator, etc. via transceiver 216. In some implementations, communication apparatus 210 may further include a memory 214 coupled to processor 212 and capable of being accessed by processor 212 and storing data therein. In some implementations, communication apparatus 220 may also include a transceiver 226 coupled to processor 222 and capable of wirelessly transmitting and receiving data. In other words, processor 222 may transceive the data such as configuration, message, signal, information, indicator, etc. via transceiver 226. In some implementations, communication apparatus 220 may further include a memory 224 coupled to processor 222 and capable of being accessed by processor 222 and storing data therein. In some implementations, network apparatus 230 may also include a transceiver 236 coupled to processor 232 and capable of wirelessly transmitting and receiving data. In other words, processor 232 may transceive the data such as configuration, message, signal, information, indicator, etc. via transceiver 236. In some implementations, network apparatus 230 may further include a memory 234 coupled to processor 232 and capable of being accessed by processor 232 and storing data therein. Accordingly, communication apparatus 210, communication apparatus 220 and network apparatus 230 may wirelessly communicate with each other via transceiver 216, transceiver 226 and transceiver 236, respectively. To aid better understanding, the following description of the operations, functionalities and capabilities of each of communication apparatus 210, 220 and network apparatus 230 is provided in the context of a mobile communication environment in which communication apparatus 210, 220 are implemented in or as a communication apparatus or a UE and network apparatus 230 is implemented in or as a network node of a communication network.

In some implementations, each of memory 214, 224 and memory 234 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214, 224 and memory 234 may include a type of read-only memory (ROM) such as mask ROM, programmable ROM (PROM), erasable programmable ROM (EPROM) and/or electrically erasable programmable ROM (EEPROM). Alternatively, or additionally, each of memory 214, 224 and memory 234 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

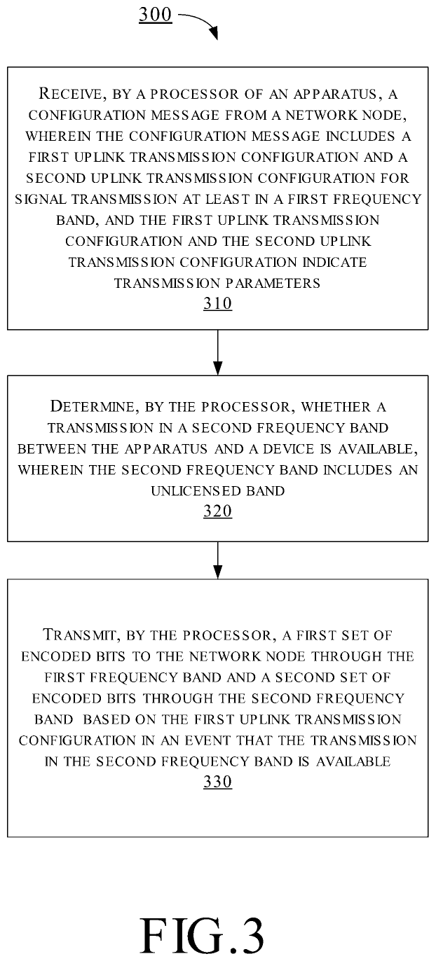

FIG. 3 illustrates an example process 300 in accordance with an implementation of the present disclosure. Process 300 may be an example implementation of above scenarios/schemes, whether partially or completely, with respect to device collaboration in an unlicensed band in mobile communications of the present disclosure. Process 300 may represent an aspect of implementation of features of communication apparatus 210. Process 300 may include one or more operations, actions, or functions as illustrated by one or more of blocks 310 to 330. Although illustrated as discrete blocks, various blocks of process 300 may be divided into additional blocks, combined into fewer blocks, or eliminated, depending on the desired implementation. Moreover, the blocks of process 300 may be executed in the order shown in FIG. 3 or, alternatively, in a different order. Process 300 may be implemented by communication apparatus 210 or any suitable communication device or machine type devices. Solely for illustrative purposes and without limitation, process 300 is described below in the context of communication apparatus 210. Process 300 may begin at block 310.

At block 310, process 300 may involve processor 212 of communication apparatus 210 receiving a configuration message from a network node. The configuration message may include a first uplink transmission configuration and a second uplink transmission configuration for signal transmission at least in a first frequency band. The first uplink transmission configuration and the second uplink transmission configuration may indicate transmission parameters. Process 300 may proceed from block 310 to block 320.

At block 320, process 300 may involve processor 212 determining whether a transmission in a second frequency band between communication apparatus 210 and a device is available. The second frequency band may include an unlicensed band. Process 300 may proceed from block 320 to block 330.

At block 330, process 300 may involve processor 212 transmitting a first set of encoded bits to the network node through the first frequency band and a second set of encoded bits through the second frequency band based on the first uplink transmission configuration in an event that the transmission in the second frequency band is available.

In some implementations, the second uplink transmission configuration may be obtained/received (e.g., implicitly) by following a part of the transmission parameters provided in the first uplink transmission configuration. Process 300 may involve processor 212 treating the first set of transmission parameters as the second uplink transmission configuration to be followed when the transmission in the second frequency band is not available.

In some implementations, the first uplink transmission configuration may indicate a first set of transmission parameters for transmitting the first set of encoded bits through the first frequency band and a second set of transmission parameters for transmitting the second set of encoded bits through the second frequency band.

In some implementations, the first set of transmission parameters may include at least one of a first RI, a first MCS, a first TPMI and a first DMRS configuration, and the second set of transmission parameters may include at least one of a second RI, a second MCS, a second TPMI and a second DMRS configuration.

In some implementations, the first set of encoded bits may correspond to a first CW or a first TB, and the second set of encoded bits may correspond to a second CW or a second TB.

In some implementations, process 300 may further involve processor 212 receiving a control message from the network node for retransmission of data carried by at least one of the first set of encoded bits and the second set of encoded bits, and retransmitting the data to the network node through the first frequency band according to the control message.

In some implementations, process 300 may further involve processor 212 transmitting a third set of encoded bits to the network node through the first frequency band based on the second uplink transmission configuration in an event that the transmission in the second frequency band is not available.

In some implementations, the second uplink transmission configuration may indicate a third set of transmission parameters for transmitting the third set of encoded bits. The third set of transmission parameters may include at least one of a third RI, a third MCS, a third TPMI and a third DMRS configuration. The third set of encoded bits corresponds to a third CW or a third TB.

In some implementations, process 300 may further involve processor 212 transmitting an uplink report message to the network node. The uplink report message may indicate which one of the first uplink transmission configuration and the second uplink transmission configuration is used for uplink transmission in the first frequency band or whether the transmission in the second frequency band is available.

In some implementations, process 300 may further involve processor 212 transmitting a first set of reference signals associated with the first set of encoded bits to the network node and a second set of reference signals associated with the second set of encoded bits in the second frequency band in an event that the transmission in the second frequency band is available.

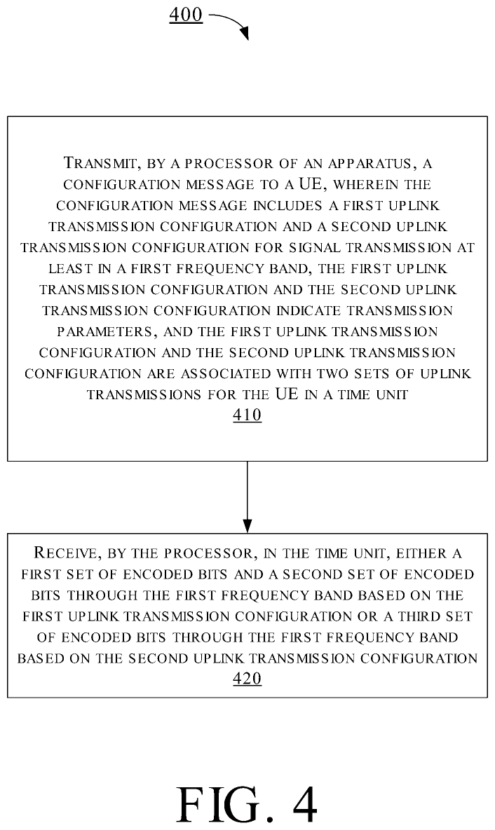

FIG. 4 illustrates an example process 400 in accordance with an implementation of the present disclosure. Process 400 may be an example implementation of above scenarios/schemes, whether partially or completely, with respect to device collaboration in an unlicensed band in mobile communications of the present disclosure. Process 400 may represent an aspect of implementation of features of network apparatus 230. Process 400 may include one or more operations, actions, or functions as illustrated by one or more of blocks 410 to 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by network apparatus 230 or any suitable network device or machine type devices. Solely for illustrative purposes and without limitation, process 400 is described below in the context of network apparatus 230. Process 400 may begin at block 410.

At block 410, process 400 may involve processor 232 of network apparatus 230 transmitting a configuration message to a UE. The configuration message may include a first uplink transmission configuration and a second uplink transmission configuration for signal transmission at least in a first frequency band. The first uplink transmission configuration and the second uplink transmission configuration may indicate transmission parameters. The first uplink transmission configuration and the second uplink transmission configuration may be associated two different sets of uplink transmissions for the UE in a time unit. Process 400 may proceed from block 410 to block 420.

At block 420, process 400 may involve processor 232 receiving, in the time unit, either a first set of encoded bits and a second set of encoded bits through the first frequency band based on the first uplink transmission configuration or a third set of encoded bits through the first frequency band based on the second uplink transmission configuration.

In some implementations, the second uplink transmission configuration may be configured (e.g., implicitly) by using a part of the transmission parameters provided in the first uplink transmission configuration. Process 400 may involve processor 232 configuring the second set of transmission parameters as the first uplink transmission configuration for the UE to use when the transmission in the second frequency band is not available.

In some implementations, the first set of encoded bits and the second set of encoded bits are received on a same set of resource blocks in the first frequency band.

In some implementations, the first uplink transmission configuration may indicate a first set of transmission parameters for transmitting the first set of encoded bits and a second set of transmission parameters for transmitting the second set of encoded bits.

In some implementations, the first set of transmission parameters may include at least one of a first RI, a first MCS, a first TPMI and a first DMRS configuration, and the second set of transmission parameters may include at least one of a second RI, a second MCS, a second TPMI and a second DMRS configuration.

In some implementations, the first set of encoded bits may correspond to a first CW or a first TB, and the second set of encoded bits may correspond to a second CW or a second TB.

In some implementations, the second uplink transmission configuration may indicate a third set of transmission parameters for transmitting the third set of encoded bits. The third set of transmission parameters may include at least one of a third RI, a third MCS, a third TPMI and a third DMRS configuration. The third set of encoded bits may correspond to a third CW or a third TB.

In some implementations, process 400 may further involve processor 232 transmitting a control message to the UE for retransmission of data carried by at least one of the first set of encoded bits and the second set of encoded bits, and receiving the data according to the control message.

In some implementations, process 400 may further involve processor 232 receiving an uplink report message from the UE. The uplink report message may indicate that which one of the first uplink transmission configuration and the second uplink transmission configuration is used for uplink transmission in the first frequency band.

In some implementations, process 400 may further involve processor 232 determining whether a set of reference signals associated with the second set of encoded bits is received in the first frequency band, and determining that the first uplink transmission configuration is used for uplink transmission in an event that the set of reference signals is received.

In some implementations, process 400 may further involve processor 232 determining that the second uplink transmission configuration is used for uplink transmission in an event that the set of reference signals is not received.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration message from a network node, wherein the configuration message includes a first uplink transmission configuration and a second uplink transmission configuration for signal transmission at least in a first frequency band, wherein the first uplink transmission configuration and the second uplink transmission configuration indicate transmission parameters;
determining, by the processor, whether a transmission in a second frequency band between the apparatus and a device is available, wherein the second frequency band includes an unlicensed band; and
transmitting, by the processor, a first set of encoded bits to the network node through the first frequency band and a second set of encoded bits through the second frequency band based on the first uplink transmission configuration in an event that the transmission in the second frequency band is available.

2. The method of claim 1, wherein the second uplink transmission configuration is obtained by following a part of the transmission parameters provided in the first uplink transmission configuration.

3. The method of claim 1, wherein the first uplink transmission configuration indicates a first set of transmission parameters for transmitting the first set of encoded bits and a second set of transmission parameters for transmitting the second set of encoded bits.

4. The method of claim 3, wherein the first set of transmission parameters includes at least one of a first rank indication (RI), a first modulation and coding scheme (MCS), a first transmission precoding matrix indicator (TPMI) and a first demodulation reference signal (DMRS) configuration, and the second set of transmission parameters includes at least one of a second RI, a second MCS, a second TPMI and a second DMRS configuration.

5. The method of claim 1, wherein the first set of encoded bits corresponds to a first codeword (CW) or a first transport block (TB), and the second set of encoded bits corresponds to a second CW or a second TB.

6. The method of claim 5, further comprising:
receiving, by the processor, a control message from the network node for retransmission of data carried by at least one of the first set of encoded bits and the second set of encoded bits; and
retransmitting, by the processor, the data to the network node according to the control message.

7. The method of claim 1, further comprising:
transmitting, by the processor, a third set of encoded bits to the network node through the first frequency band based on the second uplink transmission configuration in an event that the transmission in the second frequency band is not available.

8. The method of claim 7, wherein the second uplink transmission configuration indicates a third set of transmission parameters for transmitting the third set of encoded bits, the third set of transmission parameters includes at least one of a third RI, a third MCS, a third TPMI and a third DMRS configuration, and the third set of encoded bits corresponds to a third CW or a third TB.

9. The method of claim 1, further comprising:
transmitting, by the processor, an uplink report message to the network node, wherein the uplink report message indicates which one of the first uplink transmission configuration and the second uplink transmission configuration is used for uplink transmission in the first frequency band or whether the transmission in the second frequency band is available.

10. The method of claim 1, further comprising:
transmitting, by the processor, a first set of reference signals associated with the first set of encoded bits in the first frequency band to the network node and a second set of reference signals associated with the second set of encoded bits in the second frequency band in an event that the transmission in the second frequency band is available.

11. A method, comprising:
transmitting, by a processor of an apparatus, a configuration message to a UE, wherein the configuration message includes a first uplink transmission configuration and a second uplink transmission configuration for signal transmission at least in a first frequency band, wherein the first uplink transmission configuration and the second uplink transmission configuration indicate transmission parameters, and the first uplink transmission configuration and the second uplink transmission configuration are associated with two different sets of uplink transmissions for the UE in a time unit; and
receiving, by the processor, in the time unit, either a first set of encoded bits and a second set of encoded bits through the first frequency band based on the first uplink transmission configuration or a third set of encoded bits through the first frequency band based on the second uplink transmission configuration.

12. The method of claim 11, wherein the second uplink transmission configuration is configured to follow a part of the transmission parameters provided in the first uplink transmission configuration.

13. The method of claim 11, wherein the first set of encoded bits and the second set of encoded bits are received on a same set of resource blocks in the first frequency band.

14. The method of claim 11, wherein the first uplink transmission configuration indicates a first set of transmission parameters for transmitting the first set of encoded bits and a second set of transmission parameters for transmitting the second set of encoded bits.

15. The method of claim 13, wherein the first set of transmission parameters includes at least one of a first RI, a first MCS, a first TPMI and a first DMRS configuration, and the second set of transmission parameters includes at least one of a second RI, a second MCS, a second TPMI and a second DMRS configuration.

16. The method of claim 11, wherein the first set of encoded bits corresponds to a first CW or a first TB, and the second set of encoded bits corresponds to a second CW or a second TB.

17. The method of claim 11, wherein the second uplink transmission configuration indicates a third set of transmission parameters for transmitting the third set of encoded bits, the third set of transmission parameters includes at least one of a third RI, a third MCS, a third TPMI and a third DMRS configuration, and the third set of encoded bits corresponds to a third CW or a third TB.

18. The method of claim 11, further comprising:
transmitting, by the processor, a control message to the UE for retransmission data carried by at least one of the first set of encoded bits and the second set of encoded bits; and
receiving, by the processor, the data according to the control message.

19. The method of claim 11, further comprising:
receiving, by the processor, an uplink report message from the UE, wherein the uplink report message indicates that which one of the first uplink transmission configuration and the second uplink transmission configuration is used for uplink transmission in the first frequency band.

20. The method of claim 11, further comprising:
determining, by the processor, whether a set of reference signals associated with the second set of encoded bits is received in the first frequency band; and
determining, by the processor, that the first uplink transmission configuration is used for uplink transmission in an event that the set of reference signals is received.

21. The method of claim 20, further comprising:
determining, by the processor, that the second uplink transmission configuration is used for uplink transmission in an event that the set of reference signals is not received.

22. An apparatus, comprising:
a transceiver which, during operation, wirelessly communicates with a network node; and
a processor communicatively coupled to the transceiver such that, during operation, the processor performs operations comprising:
receiving, via the transceiver, a configuration message from a network node, wherein the configuration message includes a first uplink transmission configuration and a second uplink transmission configuration for signal transmission at least in a first frequency band, wherein the first uplink transmission configuration and the second uplink transmission configuration indicate transmission parameters;
determining whether a transmission in a second frequency band between the apparatus and a device is available, wherein the second frequency band includes an unlicensed band; and
transmitting, via the transceiver, a first set of encoded bits to the network node through the first frequency band and a second set of encoded bits through the second frequency band based on the first uplink transmission configuration in an event that the transmission in the second frequency band is available.
